(19) United States
(12) Patent Application Publication
(10) Pub. No.: US 2015/0180831 A1
(43) Pub. Date: Jun. 25, 2015

(54) Bigoted IPv6 Filtering Apparatus

(71) Applicant: BARRACUDA NETWORKS, INC., CAMPBELL, CA (US)

(72) Inventor: Jeremy P. Bowers, Brighton, MI (US)

(73) Assignee: BARRACUDA NETWORKS, INC., Campbell, CA (US)

(21) Appl. No.: 13/902,161

(22) Filed: Dec. 20, 2013

(51) Int. Cl. H04L 29/06; H04L 29/12

(52) U.S. Cl. CPC H04L 63/0236; H04L 61/6059; H04L 63/20

(57) ABSTRACT

An apparatus accesses many locations of a store for information about a specific Internet Protocol address. A filter concentrates and condenses a diffuse population widely dispersed in a ginormous address range into a smaller storage space with controllable error rate. A cloud service acquires, aggregates, and distributes IP address data structure records from and to globally distributed network access devices. A system of filter elements operating in parallel determines a plurality of storage addresses in memory to represent Internet Protocol addresses categorized for security. A method determines a plurality of storage addresses from each Internet Protocol address so characteristics of the IP address can be accessed at the storage addresses.

### RELATED APPLICATIONS

None

### BACKGROUND

Current proven network security technologies and philosophies are conventionally believed not to scale with the conversion of Internet Protocol (IP) addresses from 1Pv4 to 1Pv6 thereby leading to the end of blacklists/blocklists as we know them.

Many conventional networking applications include a step where we decide whether we are even going to accept a connection from a given source; for instance, we may wish to not even receive email from a known spammer, or we may wish to block HTTP connections to a known spyware site. We do this because it's a very cheap operation if we can make this decision before we even do anything else, and is a critical component of providing these services at scale. While we have many ways of analyzing an email to see if it is spam, they are all more expensive than rejecting a connection request from an email server due to IP address blacklisting.

As computers and storage technologies have advanced, 1Pv4 blacklisting has become ever more practical, to the point today when if necessary one could trivially create a bit array in memory, where each bit represents one IP address, and we blacklist addresses for which the bit is 1. This requires half a gigabyte; what was once a prohibitive amount of memory is now something that our cell phones could do without much stress. This is because there are only 2″32 1Pv4 addresses in total.

As this is fewer than the number of people currently alive, in future 1Pv4 isn't going to be enough. 1Pv6 was created to address the IP address shortage. It has 2″ 1 28 addresses, although for various reasons for an IP filtering product this may be “only” 2″64 addresses. Nevertheless, in a world where 1Pv6 addresses are common, this is greatly more than any current conventional blacklist can handle. In particular, because these are handed out in large blocks, it will be feasible for spammers to send emails in a manner in which they use a new IP for every email.

It is commonly thought that IP address filtering must inevitably fall by the wayside in the coming 1Pv6 universe. For instance, see: http://www.internet-security.ca/internet-security-news-archives-030/new-ipv6-internet-protocol-could-complicate-e-mail-spam-filtering.html

What is needed is a way to recover some of the advantages of blacklisting for 1Pv6 addresses in a manner which is computationally efficient and economical for client devices.

One approach that has been discarded is a conventional Bloom filter which is a well-known computer science method (by Burton Howard Bloom 1970) for providing lookups of information in a space-effective manner, in a relatively small number of bits per lookup item, at the potential cost of false positives. The core data structure is a bit array where the bits are individually indexed (so one can feasibly talk about the 342nd bit of the structure, for instance, the usual byte distinctions are not relevant).

To insert an item, the same hash functions are run, and the given bits are set to 1.

This has the attraction of being able to store large numbers of values with small numbers of bits per value required to store it with reasonable false positive rates. For every ˜5 bits per item, the false positive rate goes down by ˜10. At 10 bits, one has about a 1% error rate, at 15, about 0.1%, and so on.

However, looking forward to the spammer who is using a new IP address for each email, this still adds up too quickly to be practical. It is feasible for a spammer to have a 48-bit part of the 1Pv6 address space, which is itself 65,656 times larger than the entire Internet of today. 2Λ48*16 bits (for convenient multiplication) still results in a ˜560 petabyte Bloom filter being required, just for this one spammer. Any attempt to fit this datastructure in a practical amount of space will result in the Bloom filter rapidly containing nothing but 1 s, resulting in every query returning that the target IP address is a spammer's IP, falsely. And with modern 1Pv6 allocation, most networks will end up with even radically larger sets of IP addresses.

Bloom filters are not new and no one over the last 40 years has overcome the core problem with applying Bloom filter to an 1Pv6 address space problem: when we go to update the Bloom filter, a conventional approach cannot constrain where the 1 bits will be set. One spammer marching through their little subnet essentially corrupts the entire Bloom filter. Thus a Bloom filter cannot scale to the 1Pv6 address task.

What is needed is a higher performance, parallelizable and distributable system to filter 1Pv6 addresses enabling an acceptance or denial of connections in real time.

### BRIEF DESCRIPTION OF DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope.

FIG. 1 is a data flow diagram of a system according to the subject matter;

FIG. 2. is a schematic of an C×b array of filter elements;

FIG. 3 is an illustration of a scalable architecture to transform a Full IP address into a plurality of SAddress values for controlling access to a data store;

FIG. 4 is non-limiting example of pseudo-code as a model of instructions which when executed cause the disclosed access to data store and resulting decision.

### SUMMARY OF THE INVENTION

In short, the invention may be practiced by a Network card, a Network access control module (determining if access to or from a resource is permitted), cloud storage infrastructure for receiving bad addresses and storing them, and a set of servers which will process the blacklist and would send a processed data structure to the network access control modules if only the participant devices could look up an incoming 1Pv6 address efficiently in the processed data structure. If other users combine their forces, as disclosed below, it could be done.

Many distributed client filter users operate client devices which detect Internet Protocol addresses which host content which is malicious, undesirable, or suspicious. This is time consuming and we wish to prevent redundant consumption of these client device resources. Each client uploads a list of IP addresses and in turn receives a database of aggregated results of every other client's parallel evaluation of IP addresses.

IP addresses are gathered by a server and provided to a filter information storage cloud. Either whiteout or blackout coded stores may be maintained or they may be aggregated together. An administrative override can correct false positives or resolve conflicts and remove stale data.

Multiple locations in the storage architecture are encoded for each IP address and its evaluation. Several filter apparatuses may be operated in parallel to determine the addresses in which the codes will be written. The codes of several storage systems may be easily combined using logical OR operations into a distribution package.

The IP address is masked several times with more and more least significant bits cut off. At each step, an ever larger modulus is configured for determining a transformation. Each transformation operates on the masked IP address and the result of the previous transformation, if available. The result of the final transformation determines an access address in a store which may be read from or written into.

While this is distinguishable from a Bloom filter, it is complementary by being sufficiently compatible with most known elaborations on Bloom filters to continue to work. A standard “whitelist” filter can be added if it desirable, small values can be associated with keys, etc. This could easily be embodied in ASIC hardware for faster lookup or FPGA for flexibility, or just software for cost.

When the distribution package is distributed to client filter users, they may use the same filter process embodied in hardware or as software to determine, if an IP address is already known, if a requested connection should be allowed or denied, eliminating a costly and redundant content inspection process.

### DETAILED DISCLOSURE OF EMBODIMENTS

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

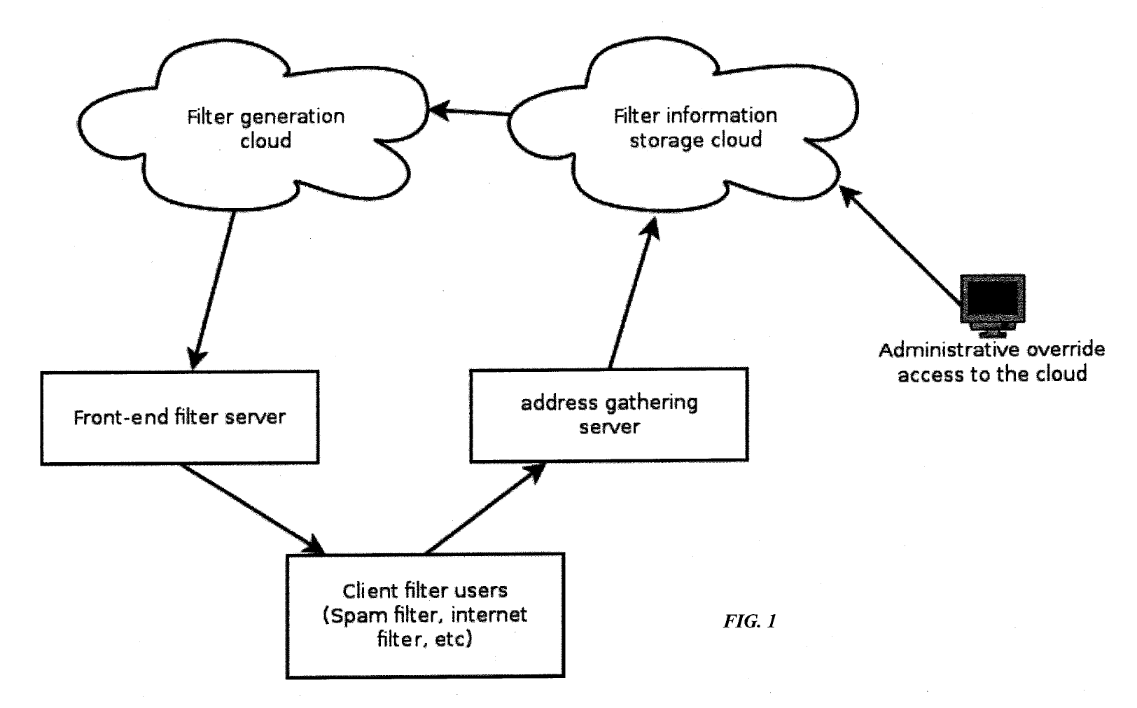

Referring now to FIG. 1 in a system embodiment, client devices receive globally aggregated filter results and submit new websites to be incorporated into a cloud based service; parallel filter servers receive IP addresses, access a storage architecture, annotate address locations with codes, and globally aggregate subresults; administrative workstations overrule and overwrite determinations such as asserting whiteout for trusted IP addresses; and, closing the loop, a server distributes aggregated results to update client devices.

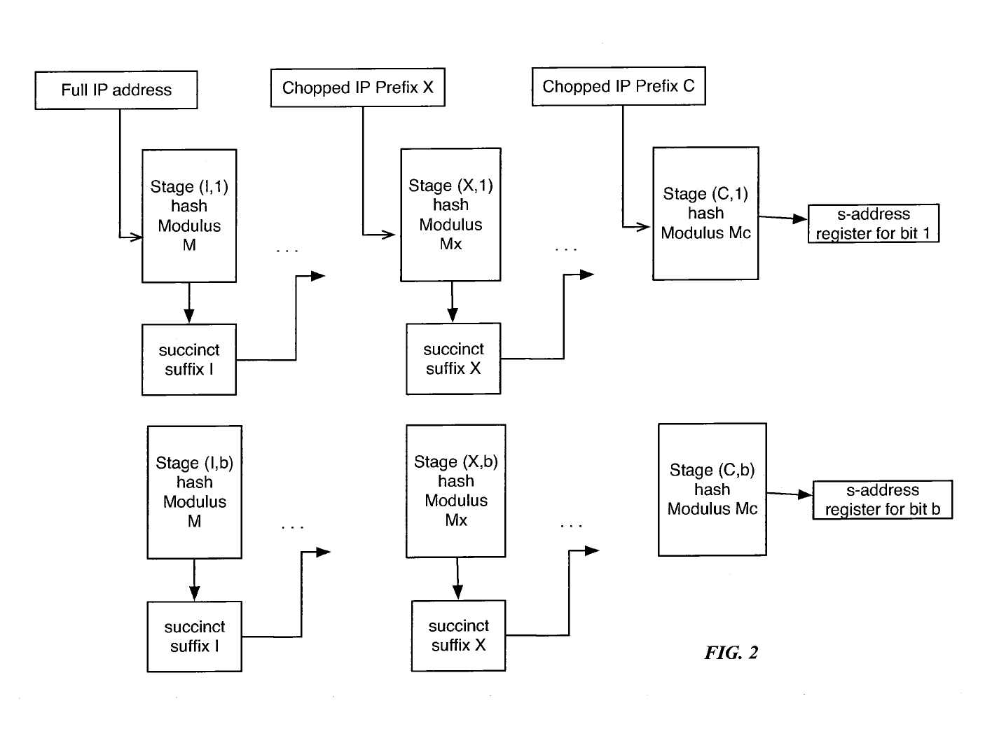

Referring now to FIG. 2, an apparatus embodiment comprises an array of filter elements. The array Cxb provides a number of stages C to compute an s-address for each bit: 1 through b. A representative filter element (X,b) is in a pipeline that generates an s-address for bit b. Filter element X receives a succinct suffix X−1 from its preceding stage and an IP prefix which has been chopped or truncated or masked according to its stage X (between I and C). Each filter element of a stage is configured with a corresponding modulus which changes as a function of X. The first stage of the array provides the full unmasked, untruncated, unchopped IP address to each of its b filter elements. Each subsequent stage has a larger mask or chops increasingly more of the IP address leaving the final stage with only the most significant bits of the IP address. Because the modulus increases with each subsequent stage, each succinct suffix is larger than the preceding succinct suffix and the s-address is larger than any of the succinct suffixes used to generate it.

In lieu of a preceding stage for stage I, the input for the succinct suffix is simply set to the bit value of the filter row (1 . . . b). The outputs of Stage C, the final stage of the filter are the s-addresses in nontransitory storage.

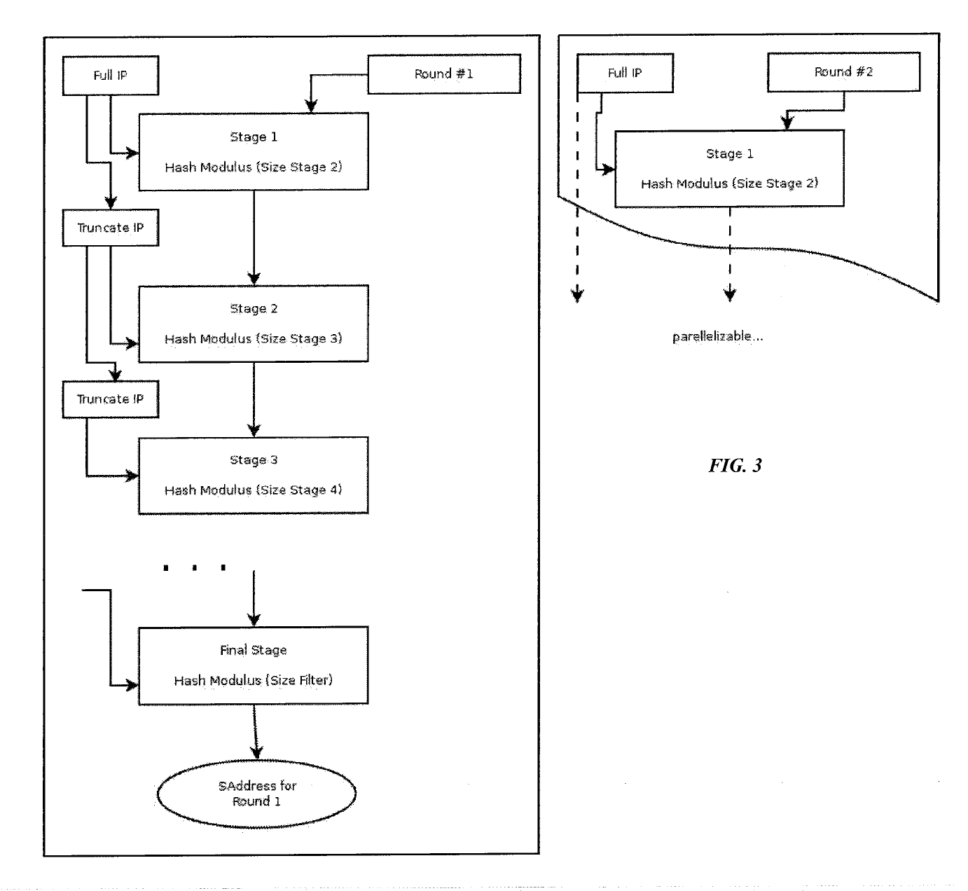

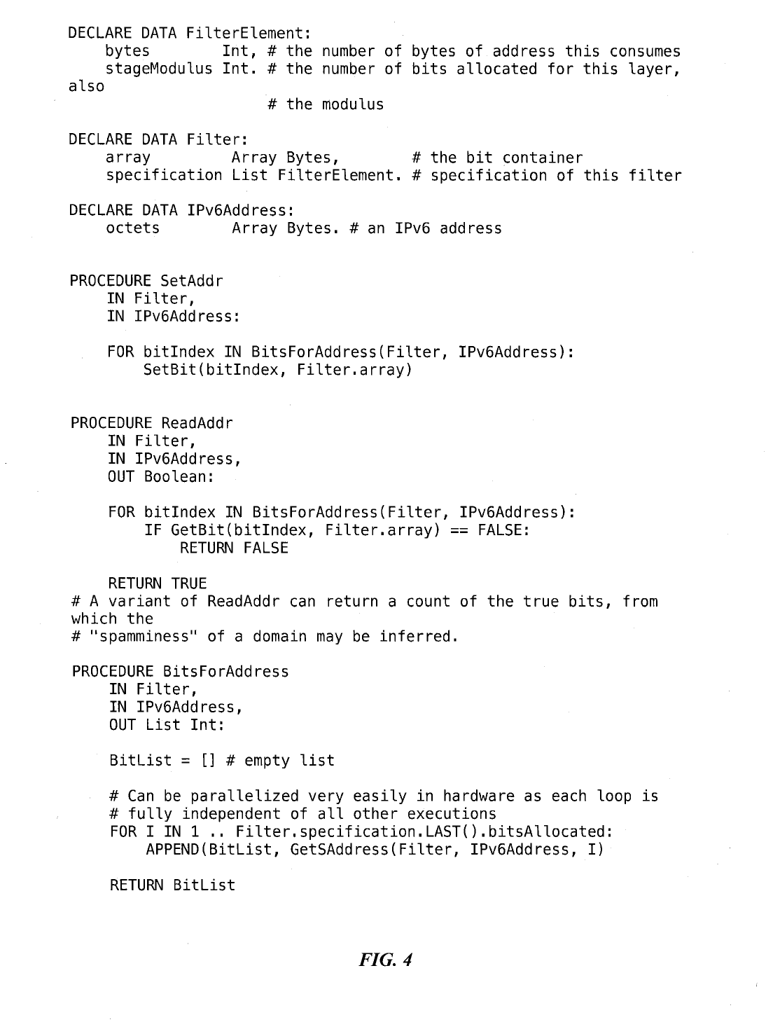

Referring now to FIG. 3, a functional view of a scalable architecture is presented. In this view, a plurality of stages are coupled from top to bottom in a silo. Each stage of a silo comprises a hash circuit. Stage 1 hash circuits of all silos receive the same full IP address as an input. Each following stage receives a truncated IP address with the truncation of the least significant bit being the greatest at the final stage. Each stage is configured with a hash modulus which is sized according to the following stage. In general the hash modulus for a later stage is greater than the hash modulus preceding it. Except for the final stage, the output of the stage is an input to the following stage. The output of the final stage is an SAddress which is used to access a location in data store. The number of bits to be set in the data store for each IP address determines b the number of numbered silos of stages. An input to stage 1 of silo 1 may be 1. An input to stage 1 of silo 2 may be 2. An input to stage 1 of silo b may be b. What is important is that b silos transform the IP address into b different SAddresses to be written to or read from.

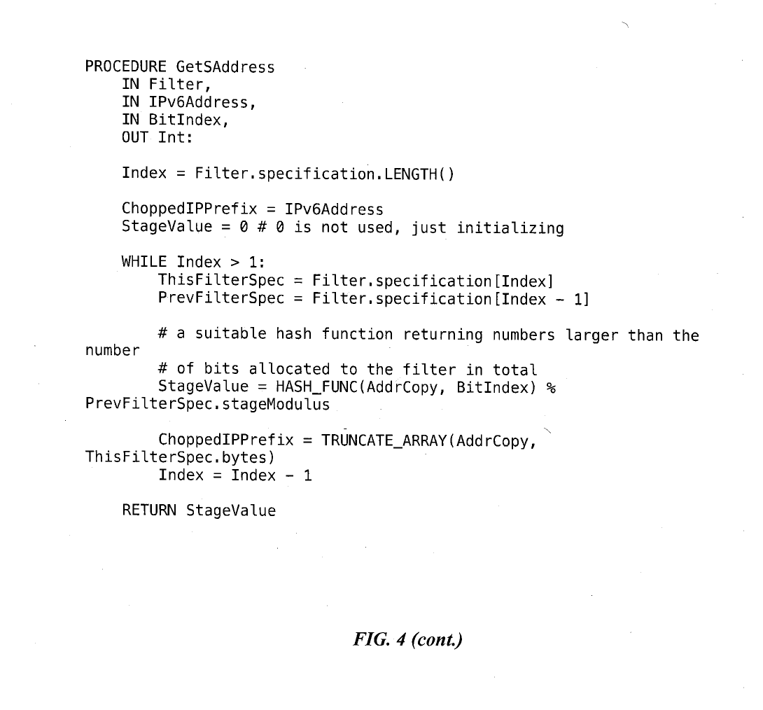

Referring now to FIG. 4, pseudo-code illustrates a model embodiment of the invention as instructions which when executed by a processor cause the transformation of an IP address into a plurality of SAddress locations to access a data store and determine when an 1Pv6 Address corresponds to a blacklisted spam source. All of the bits being set indicate that the site has been determined as a spam source. While there are false positives, more bits in the computation (width of the filter) provide higher confidence. Advantageously, when a spam sender controls and uses a range of IP addresses, the SAddress locations for his as yet unused IP addresses begin to be increasingly set as we accumulate data. So the fraction of SAddress bits set suggest an analog probability of an IP address being within the spammer's IP address space. The method steps can be parallelized by multiple cores or multiple processors in a cloud service. The depth of the filter (number of stages) can evolve as best practices or conventions are measured for economy and performance. FIG. 4 includes instructions suitable for use in client devices which need to enable or reject connections to the IP address presented.

A filter is implemented at each of the clients and in one or more cloud services which has: an input register for reception of an Internet Protocol address; an output register for emission of a plurality of saddresses for accessing a non-transitory store; a C stage filter comprising an array of sequentially coupled filter elements; wherein each of C stages has b filter elements in parallel; wherein each filter element of a stage is configured with the same IP address mask and the same Modulus; wherein except for the first stage, each filter element receives a masked IP address and a succinct suffix from the stage preceding it, wherein except for the final stage, each filter element transforms the received succinct suffix and the masked IP address into a generated succinct suffix; wherein each filter element of the final stage is coupled to an s-address register into which it stores the result of transforming the received succinct suffix and the masked IP address; wherein each first filter element transforms the full IP address with the integer value of the bit of the filter it initiates instead of a succinct suffix.

Each of the filters causes the following operations: receiving a modulus and a mask; receiving and masking an IP address; receiving and transforming a first succinct suffix; wherein transforming includes performing a hash using the masked IP address, the received succinct suffix, and the modulus; whereby a new second succinct suffix is generated.

In an exemplary embodiment, the method enables a flexible and ad hoc manner of partitioning the IP address. This is a configurable parameter that will be changed over time to reflect experience and the layout of the 1Pv6 network, but for expository purposes, we will choose 2-byte chunks of the address for the first 8 bytes, and treat the last 8 bytes as one element. (This non-limiting example demonstrates that the partitions can be freely chosen, and demonstrates that they need not be homogeneous.)

12:34: 56:78: 9a:bc: de:fO: 12:34:56:78:9a:bc:de:f0

Configuration of each embodiment enables selection of the following numbers:

*The total number of bits allocated for the filter
*For each chunk of the IP address, a number of bits allocated to that chunk, from left to right Each number chosen must be smaller than the last. Suppose we are going to allocate 32 million bits to the filter. We might allocate the chunks as so:

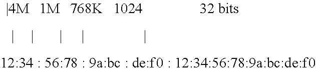

Each number chosen must be smaller than the last, but various effects can be obtained within that constraint, which can be used to reflect actual 1Pv6 network structure.

The method applies any hash function that takes in an arbitrary series of bytes, and returns a number larger than the total number of bytes. (This is easy to obtain.) Using this function hf( ), the method performs the following lookup procedure:

1. For Las the number of bits allocated to the least significant portion (here 32), and H the number of bits allocated to the next most significant segment (here 1024) determine the following values:
hf(IP address, L)% H
This provides a number in the range 0-(H−1), or here, 0-1023.
2. For each of the remaining segments in reverse order, operate on IP address up to that point (masking lsb), and the result from the previous transformation, and modulus it with the number of bits allocated to the previous segment.
3. When performed at the final segment, configure the total number of bits allocated as the modulus. Use this final result as the lookup value (access method storage address) for the filter check.

A non-limiting example will probably assist in appreciation of the novelty and advantages of the subject matter. In this case, the computation chain for the third bit is as follows (with made up values for the hash values):

hf(12:34:56:78:9a:bc:de:f0: 12:34:56:78:9a:bc:de:f0, 3)% 1024=834
hf(12:34: 56:78: 9a:bc: de:fO, 834)% 768000=398382
hf(12:34: 56:78: 9a:bc, 398382)% 1,000,000=838,399
hf(12:34: 56:78, 838399)% 4,000,000=3,284,854
hf(12:34, 3,284,854)% 32,000,000=19,375,394

Note the first place we reuse the previous value 834 is the second argument of the hash function, the subsequent lines follow the same pattern. Thus, for this part of the filter lookup, we will consult bit 19,375,394 in the final filter structure. As we repeat this applying each of the numbers 0 through 31 to the same IP address, we will obtain 32 numbers in the range 0 to 32 million, which we will use as lookups into the original bit array.

This has the novel effect of partitioning the filter (because it is the observation of the Applicant that the IP address data is hierarchical in nature) to contain the damage one bad actor can do with a network. Even if the bad actor obtains access to the entire 12:34: 56:78: 9a:bc: de:fO network space and gets every 2″64 IP addresses in that network blacklisted, they are contained by the fact that only 1024 bits (in this exemplary embodiment) will ever be flipped to 1 for them.

Moreover, as an increasing number of bits get flipped in their partition, it can be easily observed that sub network converges toward being “blacklisted”, which is a characteristic that is advantageously harnessed in the disclosed filtering context. Even though they are attacking us from a new IP each time, we very rapidly begin blacklisting the entire block. This extends up the partitions; if a bad actor gets the entire 12:34: 56:78: 9a:bc sub network, as they fill up their bits they will eventually get the entire sub network blacklisted, with minimal impact on any other networks.

However, to construct this filter manually, mentally, or even from the perspective of a single device cannot scale, so the present inventive system provides a cloud infrastructure communicatively coupled to client devices that gathers a wide array of 1Pv6 addresses that have been shown to be bad at many network attached remote clients, and will create this filter structure which can be pushed down to clients.

Each individual client device in the field will feed back up IP addresses determined to be bad by conventional measures. These values will be collected in the cloud and used to construct the filter described above, which will be periodically pushed down to all the clients. Construction of the filter is trivially parallelizable by arbitrarily breaking the construction task up between machines and performing a bitwise AND (or OR depending on notation) on the subresults.

A standard “whitelist” filter preprocessor can be added if it desirable, small values can be associated with keys, etc. This could easily be embodied in ASIC or FPGA apparatus for high performance.

To facilitate efficient storage, the backend storage cloud can store summarized data rather than storing every individual subnet as blocked. Using the current values for the filter, once we observe that we have enough bad values from a given netblock to result in ones for that entire block, we can just pull it out of the data structure and apply a regex block to most significant bits. This condition is easily observed simply by walking across all possible bits for that block. In an embodiment the method also maintains a potential blacklist that only operates at higher levels, for instance, entirely blocking 12:34 while using this solution for more refined and automated blacklisting at other levels. This prevents 12:34 from filling up the filter, which even though it is confined, it is still more effective to use the filter for less well characterizable blacklists.

In an embodiment, a decay mechanism prevents addresses from being blocked forever. In an embodiment, prior to the next “refresh” of the filter, we set every N'th bit back to zero, rotating through the filter over a period of time, then performing the next refresh. This has the effect of releasing networks that have corrected themselves or ceased to exist from the filter. This also has the benefit of making it so the filter need only store information that is reasonably current, rather than dragging a list of every blacklisted subnet ever through all time.

Administrators are able to override the filter by storing an explicit whiteout of SAddress locations, for a site that is a false positive.

One aspect of the invention is a system comprising client devices and servers communicatively coupled on a network. The client devices of this system are configured to receive aggregated filter results in a data structure, to receive a request to connect with an Internet Protocol (IP) address, to perform a filter process to determine a plurality of locations within the data structure, and to accept or deny the connection based on the values in said locations within the data structure.

The client devices of this system are also configured to determine if the IP address is associated with malicious or undesired content and, if true, to transmit such IP address to a cloud service.

In an embodiment the system also has an address gathering server. In an embodiment the system also has a filter information storage cloud. In an embodiment the system is enabled to develop and store summarized data by walking across all possible bits for a given netblock and entirely blocking it when the a threshold is met. In an embodiment the system also has a filter generation cloud which has one or more parallel filter servers to receive IP addresses, access a storage architecture, annotate address locations with codes, and globally aggregate subresults.

In an embodiment the system also has Administrative workstations to overrule and overwrite determinations such as asserting whiteout for trusted IP addresses. In an embodiment the system also has a front end filter server to provision client devices with aggregated results. In an embodiment the system enables a determination by a client device that an 1Pv6 address serving or transmitting malicious content is transmitted to a cloud service, stored into a plurality of locations in a storage architecture, and proliferated to all other client devices communicatively connected.

In an embodiment the system enables a request for an HTTP session to a web server to be denied because the 1Pv6 address of the resolved domain name is associated with a blacklist. In an embodiment the system enables connection requests from email servers to be denied because the 1Pv6 host sender is associated with a blacklist.

One aspect of the invention is a filter apparatus to determine access addresses for a storage device to record data about an Internet Protocol address, the filter apparatus comprising: an input register for reception of an Internet Protocol address; an output register for emission of a plurality of s-addresses for accessing a non-transitory store; a C stage filter comprising an array of sequentially coupled filter elements; wherein each of C stages has b filter elements in parallel; wherein each filter element of a stage is configured with the same IP address, bitmask and the same Modulus. In an embodiment, except for the first of C stages, each filter element receives a succinct suffix from the stage preceding it. In an embodiment, except for the final stage, each filter element applies the bitmask to the least significant bits of the IP address. In an embodiment, except for the first, each of C stages transforms the received first succinct suffix and the masked IP address into a generated second succinct suffix. In an embodiment, each filter element of the final stage is coupled to an s-address register into which it stores the result of transforming the received succinct suffix and the masked IP address. In an embodiment, each first filter element transforms the full IP address with the integer value of the bit of the filter it initiates instead of a succinct suffix.

Another aspect of the invention is a method for operation of a filter element which has a processor and memory, the method comprising: receiving a modulus and a bit mask; receiving an Internet Protocol (IP) address; applying the bit mask to the least significant bits of the IP address; receiving a first succinct suffix; transforming said first succinct suffix, wherein transforming includes performing a hash using the masked IP address, the received first succinct suffix, and the modulus; and providing the transformed first succinct suffix as a second succinct suffix. In an embodiment, the first succinct suffix is an integer representing a bit number. In an embodiment, the second succinct suffix is a location in a storage device which can be accessed for a read or write operation. In an embodiment, the method further comprises reading from all the locations in the storage device to determine if the Internet Protocol address has previously been determined to be controlled by a malicious operator. In an embodiment, the method further comprises writing into all the locations in the storage device to record that the IP address is presently determined to be controlled by a malicious operator.

### CONCLUSION

A spammer's use of 1Pv6 addresses selected from a range causes the present invention to be prejudiced against other 1Pv6 addresses in the vicinity even before the spammer attempts to exploit the unused addresses he controls. Thus the invention is a bigoted filter.

The present invention can be easily distinguished from conventional methods because the magnitude of 1Pv6 makes them impractical. One of the advantageous things about this data structure transformation method is that it proactively blacklists the /48s or the /64s without waiting for a spammer's explicit usage. We can also easily configure it handle several block sizes; part of the beneficial aspect of the selective partitioning is that we can deal with changes to evolving practice without having to completely rewrite the data structure and process. As can be appreciated, embodiments of the subject matter may be done in ASIC, FPGA, programmable logic and by processors with one or more cores in parallel coupled to non-transitory storage encoded with instructions which when executed by the processors/cores cause all the specified operations in the following claims.

The techniques described herein can be implemented in digital electronic circuitry, or in computer hardware, firmware, software, or in combinations of them. The techniques can be implemented as a computer program product, i.e., a computer program tangibly embodied in a non-transitory store, e.g., in a machine-readable semiconductor, magnetic, or optical storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one core or on multiple cores of a processor at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the follow

I claim:

1. A system comprising client devices and servers communicatively coupled on a network:
the client devices configured to receive aggregated filter results in a data structure, to receive a request to connect with an Internet Protocol (IP) address, to perform a filter process to determine a plurality of locations within the data structure, and to accept or deny the connection based on the values in said locations within the data structure;
the client devices further configured to determine if the IP address is associated with malicious or undesired content and, if true, to transmit such IP address to a cloud service.

2. The system of claim 1 further comprising an address gathering server.

3. The system of claim 1 further comprising a filter information storage cloud.

4. The filter information storage cloud of claim 3 enabled to develop and store summarized data by walking across all possible bits for a given netblock and entirely blocking it when the a threshold is met.

5. The system of claim 1 further comprising a filter generation cloud which has
one or more parallel filter servers to receive IP addresses, access a storage architecture, annotate address locations with codes, and globally aggregate subresults.

6. The system of claim 1 further comprising:
Administrative workstations to overrule and overwrite determinations such as asserting whiteout for trusted IP addresses.

7. The system of claim 1 further comprising:
a front end filter server to provision client devices with aggregated results.

8. The system of claim 1 whereby a determination by a client device that an IPv6 address serving or transmitting malicious content is transmitted to a cloud service, stored into a plurality of locations in a storage architecture, and proliferated to all other client devices communicatively connected.

9. The system of claim 1 whereby a request for an HTTP session to a webserver is denied because the IPv6 address of the resolved domain name is associated with a blacklist.

10. The system of claim 1 whereby connection requests from email servers are denied because the IPv6 host sender is associated with a blacklist.

11. A filter apparatus to determine access addresses for a storage device to record data about an Internet Protocol address, the filter apparatus comprising:
an input register for reception of an Internet Protocol address;
an output register for emission of a plurality of s-addresses for accessing a non-transitory store;
a C stage filter comprising an array of sequentially coupled filter elements;
wherein each of C stages has b filter elements in parallel;
wherein each filter element of a stage is configured with the same IP address, bitmask and the same Modulus;

12. The filter apparatus of claim 11, wherein except for the first of C stages, each filter element receives a succinct suffix from the stage preceeding it.

13. The filter apparatus of claim 11, wherein except for the final stage, each filter element applies the bitmask to the least significant bits of the IP address.

14. The filter apparatus of claim 11, wherein except for the first of C stages transforms the received first succinct suffix and the masked IP address into a generated second succinct suffix.

15. The filter apparatus of claim 11, wherein each filter element of the final stage is coupled to an s-address register into which it stores the result of transforming the received succinct suffix and the masked iP address.

16. The filter apparatus of claim 11, wherein each first filter element transforms the full IP address with the integer value of the bit of the filter it initiates instead of a succinct suffix.

17. A method for operation of a filter element which has a processor and memory, the method comprising:
receiving a modulus and a bit mask;
receiving an Internet Protocol (IP) address;
applying the bit mask to the least significant bits of the IP address;
receiving a first succinct suffix;
transforming said first succinct suffix,
wherein transforming includes performing a hash using the masked IP address, the received first succinct suffix, and the modulus; and
providing the transformed first succinct suffix as a second succinct suffix.

18. The method of claim 17 wherein the first succinct suffix is an integer representing a bit number.

19. The method of claim 17 wherein the second succinct suffix is a location in a storage device which can be accessed for a read or write operation.

20. The method of claim 19, further comprising at least one of:
reading from all the locations in the storage device to determine if the Internet Protocol address has previously been determined to be controlled by a malicious operator, and
writing into all the locations in the storage device to record that the IP address is presently determined to be controlled by a malicious operator.
